(19) United States
(12) Patent Application Publication
(10) Pub. No.: US 2026/0064412 A1
(43) Pub. Date: Mar. 5, 2026

(54) Configuring publication/subscription proxies in a microservice architecture

(71) Applicant: Ciena Corporation, Hanover, MD (US)

(72) Inventor: David Miedema, Ottawa (CA)

(73) Assignee: Ciena Corporation, Hanover, MD (US)

(21) Appl. No.: 18/824,257

(22) Filed: Sep. 4, 2024

(51) Int. Cl. G06F 9/22

(52) U.S. Cl. CPC G06F 9/226

(57) ABSTRACT

Systems and methods are provided for configuring publication/subscription (pub/sub) system to perform alternative pub/sub tasks. According to one implementation, a publisher operating within a pub/sub system includes multiple modules arranged in a tree structure. A subscriber interface is arranged at a top root of the tree structure, wherein the subscriber interface is configured for communicating with one or more subscribers. Each module of a first group of the modules includes a microservice. Each module of a second group of the modules, located above a lowest level of the tree structure, acts as an intermediary pub/sub proxy module. Also, each module of the first group is configured to self-publish a telemetry message by capturing a metric and pushing the metric upward through one or more intermediary pub/sub proxy modules to the subscriber interface for publication to the one or more subscribers.

### FIELD OF THE DISCLOSURE

The present disclosure generally relates to computing. More particularly, the present disclosure relates to systems and methods for configuring publication/subscription (pub/sub) modules to act as telemetry proxies in a microservice system.

### BACKGROUND

In microservices, a publication/subscription (pub/sub) model can be defined as an arrangement that allows publishers (i.e., message producers) to communicate messages to subscribers (i.e., message consumers). An example of a microservice deployment can include a networking system with a node. In one example, a subscriber may wish to receive periodic updates of something associated with a node, e.g., power consumption at the node, whereby a publisher acting on behalf of the node can measure or obtain power consumption parameters at the node and publish updates, which can be delivered to this subscriber as well as other subscribers wishing to receive these same updates. A broker may be configured as a centralized system to receive published messages and categorize them into “topics” or “channels.” Subscribers can register or subscribe to these specific topics or channels to thereby receive the associated messages. Pub/sub systems can help software developers decouple applications into small independent building blocks or “services.” The pub/sub systems are normally configured to provide asynchronous communication, particularly when there is a detectable change in a relevant parameter (e.g., power consumption), enabling the notification of the changes to distributed subscriber systems.

### BRIEF SUMMARY

The present disclosure is directed to systems and methods for configuring a publisher to be used in a publication/subscription (pub/sub) environment. According to one implementation, a publisher operating within a pub/sub system includes multiple modules arranged in a tree structure. The publisher also includes a subscriber interface at a top root of the tree structure, wherein the subscriber interface is configured for communicating with one or more subscribers. Each module of a first group of the modules includes a microservice. Each module of a second group of the modules located above a lowest level of the tree structure acts as an intermediary pub/sub proxy module. Each module of the first group is configured to self-publish a telemetry message by capturing a metric and pushing the metric upward through one or more intermediary pub/sub proxy modules to the subscriber interface for publication to the one or more subscribers.

In some embodiments, the action of self-publishing the telemetry message may be prompted without the use of a get command from a higher-level module. Also, in some embodiments, the presence of the one or more intermediary pub/sub proxy modules enables self-publishing responsibilities to be driven down to lower levels in the tree structure where a metric can be directly captured from a microservice. Also, the metric captured by each module of the first group may include a) power, b) voltage, c) temperature, d) data service health, e) memory availability, f) CPU usage, and/or g) user log-in information.

According to some embodiments, the publisher may be implemented in a Network Element (NE) of a communication network, wherein the subscriber interface may be a) a Northbound Interface (NBI), b) a NETCONF interface, or c) a REST API. In other embodiments, the publisher may be implemented in a software program operating in an enterprise cloud, wherein the subscriber interface may be an API and/or an endpoint.

In some embodiments, the method may include a step of setting one or more flag bits in each module of the second group to enable operation of an upward push technique. The one or more flag bits are configured to indicate that the respective module is acting as an intermediary pub/sub proxy module to thereby remove a get responsibility of the module and suppress get commands from being passed to one or more lower level modules. Also, the method may include a step of configuring the subscriber interface to clear or set the one or more flag bits of each module of the second group according to whether the publisher is to be configured to enable operation of a conventional manner or the upward push technique.

In some embodiments, the subscriber interface may be configured to receive one or more telemetry messages from the first group of modules and publish the one or more telemetry messages without delay. Each module of the first group may be configured to self-publish the metric in response to one or more of a) asynchronously detecting an initial state of the respective microservice, b) asynchronously detecting a change in state of the metric, c) synchronously detecting the metric according to a time interval. One or more of the subscriber interface and second group of modules may be configured to aggregate multiple self-published metrics from itself and/or from one or more lower levels.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1-4 are block diagrams illustrating a number of different publication/subscription (pub/sub) systems, according to various embodiments.

FIG. 5 is a block diagram illustrating a pub/sub system in which the publisher has an expansive tree structure, according to various embodiments.

FIG. 6 is a diagram illustrating the development of a simpler publication strategy, according to various embodiments.

FIG. 7 is a block diagram illustrating a Network Element (NE) configured to act as a publisher, according to various embodiments.

FIG. 8 is a flow diagram illustrating a method for publishing telemetry messages in a simplified manner, according to various embodiments.

### DETAILED DESCRIPTION

In various embodiments, the present disclosure relates to publication/subscription (pub/sub) systems and methods, particularly in a microservice architecture. Pub/sub communication models allow clients (subscribers) to request data to be streamed at different times, such as (a) when a telemetry metric changes, (b) at certain periodic times, and/or other suitable times.

The pub/sub systems described herein are configured to provide an alternative strategy for publishing messages, particularly a strategy in which the responsibility for communicating telemetry information is placed on a component that actually performs a microservice. Therefore, instead of requiring a top-level broker component to send a “get” command downward through a microservice tree structure and wait for a response, the responsibility is “driven down” to a lower level in the tree. Thus, a component with the microservice can push (or self-publish) the telemetry information up through one or more proxy components to the top-level component (e.g., broker), which is then configured to publish the information. This arrangement takes the burden off of this top-level component. Thus, when this strategy is invoked, the top-level component (e.g., which may have a relatively weaker processor) does not need to perform certain processor-consuming tasks, such as coordinating get commands, following publication schedules, etc.

As described herein, telemetry information, metrics, messages, etc. (“telemetry”) are all some values that describe the operational state of a system, implementing the microservice architecture. For example, the telemetry can include power, processing capacity, memory, Performance Monitoring (PM) values in networking, OAM&P (Operations, Administration, Maintenance, and Performance) monitoring data, or any specific value describing some aspect of the operational state.

The systems and methods of the present disclosure are directed to microservice architectures that can support arbitrary depths of abstraction, encapsulation, and caching so that external requests can be proxied by one service and distributed to multiple downstream services. This allows for architectural simplicity, enhanced use of system resources via clustering, and high availability.

In the current state of the art, subscriptions cannot normally be proxied downstream generically since every “forwarding” of the subscription will result in duplication of the publications. However, the embodiments described herein provide acceptable solutions in which there is a single non-forwarded top-level publication that does a get from downstream services and then publishes, or alternatively includes a set of self-publishing services.

Having a single top-level framework-assisted publisher (e.g., broker) can be inefficient because it includes a single synchronous get command propagating across multiple downstream services. It can pose a resource bottleneck in cases where the processing could have been distributed across multiple processors. However, the embodiments of the present disclosure provide a better solution and are configured to share and distribute subscriptions to downstream services so they can each publish on their own without a centralized get. For cases where there are services that are self-publishing, the clients may need to be aware of which paths are self-publishing so it can suppress the periodic publishing requests and allow the publisher to publish on its own timeline, which can be a burden on the client. Trying to mix framework-assisted pubs and self-published services is difficult since the depth of the tree means that the nature of the publications is hidden from the client (or ancestral internal clients). However, the embodiments described herein are configured to overcome these issues.

### Proxy-Assisted and Self-Publishing

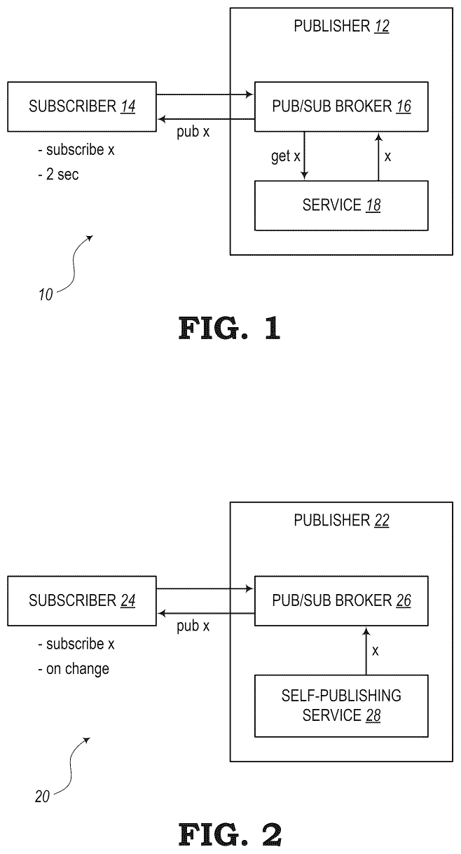

FIG. 1 is a block diagram illustrating an embodiment of a pub/sub system 10. In an embodiment, the pub/sub system 10 may be implemented in a Network Element (NE) or node of a communication network. In other embodiments, the pub/sub system 10 may be implemented in a software application, such as a cloud application. As shown, the pub/sub system 10 includes a publisher 12 and a subscriber 14. It should be understood that the pub/sub system 10 may include any number of subscribers, but only one subscriber 14 is shown in FIG. 1 for simplicity. The publisher 12 includes a pub/sub broker 16 and a service 18.

Thus, in the pub/sub system 10 with only one service 18, subscriptions are made to the service 18 and are serviced locally. There are multiple forms of publications that the subscriber 14 can subscribe to, including, for example, a) an initial state of the service 18, b) an on-change (asynchronous) upon changes to the state of the service 18, c) periodic (e.g., include a poll action and publish response every X seconds), and/or d) triggered by the subscriber 14 as a request (e.g., including a get command and a publish response).

A subscription can be handled in two different ways when it arrives at the publisher 12. Firstly, it can be “framework-assisted” or “broker-assisted,” where the pub/sub broker 16 is configured to maintain knowledge of all subscriptions and can then work to poll the service 18 with a desired frequency (e.g., every 2 seconds). In response to a “get x” command, the service 18 responds with the value “x” and the pub/sub broker 16 is configured to publish to the subscriber 14.

The embodiment of FIG. 1 having one service 18 has the following benefits:
1) The service 18 does not need any special code to handle the publications.
2) Common services can be optimized by the framework (e.g., pub/sub broker 16) to reduce overhead in processing (e.g., gets can be combined, common subscriptions can be grouped internally, etc.),
3) Common options can be easily handled by the common code (e.g., caching, subscriber matching, etc.).

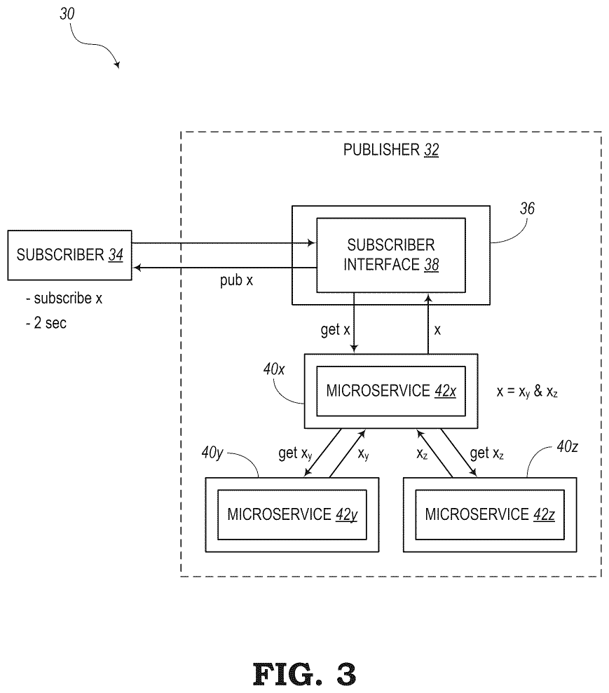

FIG. 2 is a block diagram illustrating another embodiment of a pub/sub system 20 having a publisher 22 and subscriber 24. The publisher 22 includes a pub/sub broker 26 and a self-publishing service 28. In this embodiment, publication is performed on an “on-change” (or upon detection of a change of a measurable metric). In contrast to FIG. 1, the publisher 22 of the pub/sub system 20 of FIG. 2 does not invoke a “get x” request downward. Instead, the self-publishing service 28 is configured to simply push the value “x” up to the pub/sub broker 26, which can then publish x.

Therefore, this is the second way in which a subscription can be handled. Instead of being framework-assisted or broker-assisted, the pub/sub system 20 includes self-publishing, where the responsibility if driven down to the service level, whereby the self-publishing service 28 self-publishes x. The self-publishing service 28 itself can publish data in this embodiment, whereby “publishing” or “pushing” the telemetry metric to the top level (i.e., pub/sub broker 26) can be performed at any prescribed rate. This has certain benefits as well, such as:
1) The service (i.e., self-publishing service 28) is in control over what gets published and how often,
2) Publications can be aligned with hardware clocks or external events,
3) Preprocessing and efficiencies can happen in the server for publishing that may be harder to do if it is always processed as a “get.”

When a service is self-published, the client (i.e., subscriber 24) will normally need to understand this different behavior and ask for the subscription to be “on-change” or “asynchronous.” That implies that the framework (e.g., pub/sub broker 26) will not be doing periodic queries and publishes since these may collide with messages from the self-publishing service 28. In some cases, this may not be a desirable situation, since it implies that the client needs to understand that the data is self-published from this server and needs to understand the frequency and content being published.

### Multi-service Interactions and Proxying

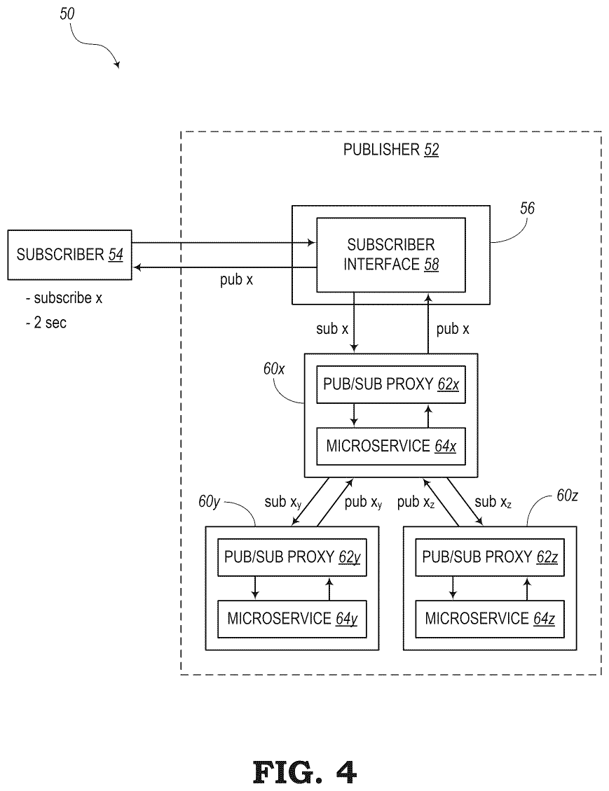

FIG. 3 is a block diagram illustrating another embodiment of a pub/sub system 30 having a publisher 32 and a subscriber 34 (or multiple subscribers). In this embodiment, the publisher 32 is configured with a tree structure having a root component 36 at the top level, the root component 36 including at least a subscriber interface 38. The tree structure of the publisher 32 further includes multiple branched components 40x, 40y, 40z extending from the root component 36. The branched components 40x, 40y, 40z each include a microservice 42x, 42y, 42z, respectively.

In this example, the subscriber 34 is registered to receive updates every two seconds regarding a value or metric “x” (e.g., power, voltage, signal strength, temperature, etc., e.g., any telemetry value). The subscriber interface 38 is configured to send a get x request down through the tree structure to the first component 40x. In this example, the component 40x may be configured to calculate or otherwise mix the metrics y and z to find x. In other words, the metric x may be a factor of or may be related in some way to metrics y and z, which may be written as x_{y} and x_{z}, respectively.

Therefore, the embodiment of FIG. 3 is a multi-service deployment with multiple microservices 42x, 42y, 42z, as opposed to a single service as described with respect to FIGS. 1 and 2. In this embodiment, the subscriber interface 38 may be configured to interact with the subscriber 34 for publication purposes, but also is configured to act as a publisher for the downstream microservices 42x, 42y, 42z. It may be noted that the tree structure can include any suitable configuration and/or may include services or microservices that branch from and/or are nested within higher level components to any depths, abstractions, and/or encapsulations.

Again, when the subscriptions are framework-assisted or broker-assisted, the top level is doing the get periodically. In the embodiment of FIG. 3, the top-level element (i.e., root component 36) includes the subscriber interface 38, which is configured to handle the broker-assistance functions. The component 40x in this case is configured to include cascaded assistance to downstream services and is configured to aggregate the results from the lower-level components 40y, 40z. In particular, the component 40x is configured to aggregate y and z to arrive at x, which is pushed to the subscriber interface 38 for publication.

It may be noted that in this embodiment where the publisher 32 includes a tree structure with multiple microservices, it would be difficult to mix the functionality of a framework-assisted (e.g., broker-assisted, assistance from the subscriber interface 38, etc.) with a self-publishing functionality as describe in FIG. 2. That is, mixing these two features would result in get commands being requested in a downward direction while self-publishing results are simultaneously pushed upward through the tree structure. This, of course, may result in duplicate messages that would cause confusion and complexity. Therefore, the components 40x, 40y, 40z in this case might not be able to act as a proxy for lower-level components and/or act as a self-publishing microservice. Another potential issue with mixing broker-assisted functionality with self-publishing functionality is that the top-level component (e.g., root component 36) may typically be unaware of the method of publication from the proxied services.

FIG. 4 is a block diagram illustrating yet another embodiment of a pub/sub system 50 having a publisher 52 and subscriber 54. The publisher 52 includes a root component 56 at the top of a tree structure, the root component 56 including at least a subscriber interface 58 configured to communicate publication messages to the subscriber 54. The embodiment shown in FIG. 4 is configured to overcome the issue discussed above regarding the combination of get messages being requested in a downward direction while self-publishing services may be pushing message upward when multiple microservices are configured in a tree architecture.

In particular, the publisher 52 includes components 60x, 60y, 60z, which are arranged in a branched configuration extending from the root component 56. The components 60x, 60y, 60z include pub/sub proxies 62x, 62y, 62z, respectively, and microservices 64x, 64y, 64z, respectively. The pub/sub proxies 62x, 62y, 62z are configured to act as a proxy for the component 60 in which it is encapsulated and for any component 60 branching therefrom in one or more lower levels.

Therefore, the problem of mixing broker-assisted get requests with self-publishing can be avoided by utilizing the pub/sub system 50 of FIG. 4. In this embodiment, the top-level subscription (i.e., x) can be broken down into multiple lower-level subscriptions (i.e., x_{y} and x_{z}), where the component 60y is configured to capture a y (or x_{y}) metric and the component 60z is configured to capture a z (or x_{z}) metric. The pub/sub proxy 62x is configured to send a subscription request for y to the component 60y and is configured to send a subscription request for z to the component 60z. In response, the component 60y returns the y metric (i.e., x_{y}) as a publication and the component 60z returns the z metric (i.e., x_{z}) as a publication.

This allows the subscription to be broken down into multiple internal subscriptions and forwarded to the deepest levels. However, the top-level framework-assisted subscription still sees the original subscription as a frequency-based subscription. Thus, the framework at the top level (e.g., root component 56) may also be doing periodic gets and publishing even though the subscription has been forwarded to downstream services. Nevertheless, since some of these levels may also support self-publishing, even if the top level is controlled so duplicate publications are avoided, at any point in the proxied subscription, a publisher may also be self-published. This too can result in duplicate publications since both the framework and the self-publishing service might be publishing. Regarding the proxied embodiments and self-publishing embodiments, the subscriber interface 58 itself, along with the pub/sub proxies 62, may control and coordinate if subscriptions are to be handled locally or by a lower-level self-publishing microservice.

### Publisher Level Coordination of Subscription Proxying

FIG. 5 is a block diagram illustrating a pub/sub system 70 with a publisher 72 and multiple subscribers 74. In this embodiment, the publisher 72 has an expansive tree structure in comparison with the simple tree structure of FIGS. 3 and 4. The publisher 72 includes a subscriber interface 76 and multiple modules 78a - 78m branching from the subscriber interface 76. According to the embodiment of FIG. 5, each module 78 may include a pub/sub proxy, such as the pub/sub proxies 62 shown in FIG. 4, and/or a microservice, such as the microservices 64 also shown in FIG. 4. However, instead of the get and response scenario (FIG. 3) and/or the proxied pub/sub scenario (FIG. 4), the pub/sub system 70 of FIG. 5 is configured to assign the responsibility of self-publishing to the lowest level possible, particularly where a telemetry metric might be captured.

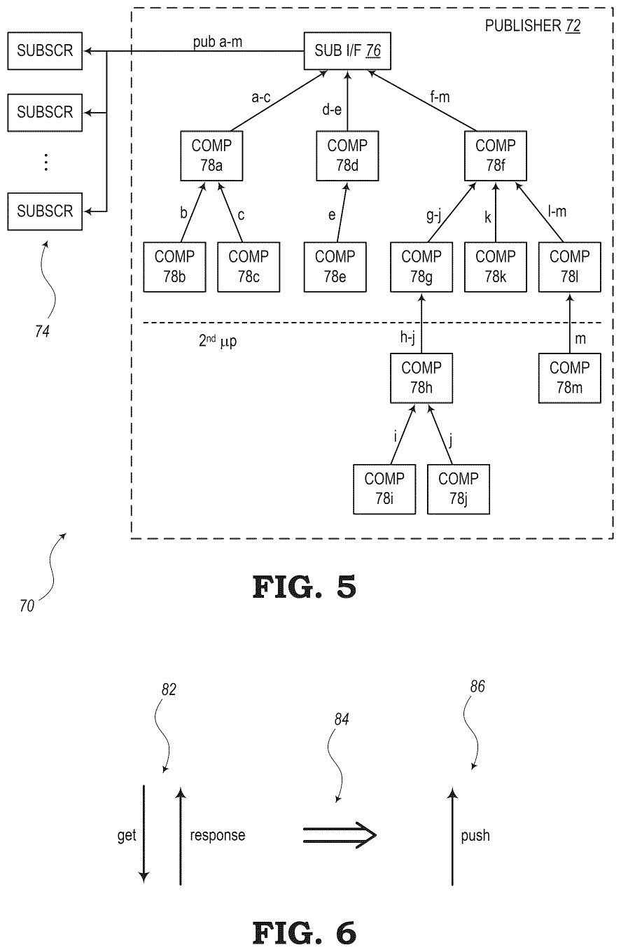

FIG. 6 is a diagram illustrating the development of a simpler publication strategy, which may be used by the pub/sub system 70 of FIG. 5 or other multi-level microservice tree structure for driving the publishing responsibilities down to a lower level of abstraction. In particular, the strategy of FIG. 6 shows an old method 82 where a get command is sent to a lower level and then waits for a response. However, by changing this strategy, a pre-configuring operation 84 is conducted to drive down the publishing duties to the lower levels so that the get and response method 82 can be replaced with a simpler upward push technique 86. The upward push technique 86 merely includes capturing the metric at the microservice, according to the timeline of its own pub/sub proxy, and transporting the metric up through the tree structure to the subscriber interface 76 through one or more other proxies, if necessary. In this way, the upper-level modules are not held up waiting for telemetry capturing events at the lower level and may simply forward the metrics up to the next level without getting involved in any pub/sub actions, unless the present module 78 uses the lower-level metric for a calculation of another metric or for combining the metric with another metric before it is forwarded upward through the hierarchy.

Referring again to FIG. 5, subscriber interface 76 and modules 78 may each include information of the topology of the tree structure. Therefore, the subscriber interface 76 may know that a first branch includes modules 78a-78c, a second branch includes modules 78d-78e, and a third branch includes modules 78f-78m, whereby metrics a-c may be obtained from the first branch, metrics d-e may be obtained from the second branch, and metrics f-m may be obtained from the third branch. Likewise, each module 78a, 78d, 78f on the next level will have knowledge of any module 78 branching therefrom, and so on. Also, the lowest level modules 78 will have knowledge that no more modules are below them. The subscriber interface 76 and a specific group of intermediary modules 78a, 78d, 78f, 78g, 78h, 78l, each configured to receive push messages from a lower branch, may be configured as proxy devices in the pub/sub system 70.

In some embodiments, the pub/sub system 70 may include additional information stored at each module 78 and the subscriber interface 76. For example, the subscriber interface 76 and modules 78 (e.g., the group of intermediary modules) may store a number of bits representing each lower-level module branching therefrom. Each bit may be a flag bit that represents whether the module 78 abides by the old method 82 (e.g., flag=0) or abides by the new method 86 (e.g., flag=1). Therefore, the functionality of the embodiments described in the present disclosure may be turned off by clearing the flags (i.e., flag=0) or can be turned on by setting the flags (i.e., flag=1).

The flag can be set for the local subscription to suppress or restrict the framework-assisted publications and/or the usage of the get commands when all or part of the subscription is proxied locally or downstream. The flag may also indicate to the subscriber interface 76 that a local get/publish should not be done. It also removes the burden of the client (e.g., subscribers 74) having to know how the downstream microservices will handle the subscription.

When the local pub/sub proxy sees the subscription, it may update the local subscription to be “proxied:true” and an optional descriptive name of the proxy for debugging. The subscription can then be handled by forwarding the subscription to downstream services or by recognizing a local self-published service.

It may be noted that the publishers 12, 22, 32, 52, 72 may be implemented in hardware and/or software. For example, the publishers may be part of a Network Element (NE), node, or other type of telecom device in a communications network. In this example, the NE may be a router, switch, multiplexer, etc. When the publisher 72 is configured as an NE, the subscriber interface 76 may be a Northbound Interface (NBI), Network Configuration Protocol (NETCONF) interface, or REpresentational State Transfer (REST) Application Programming Interface (API); and the modules 78 may be various machines, physical elements, or sensors in the NE for measuring one or more metrics. When the publisher 72 is implemented in software, the publisher 72 may be a program (e.g., running in an enterprise cloud), the subscriber interface 76 may be an API or endpoint, and the modules 78 may be containers.

Normally, a subscription might be tracked at the top level (e.g., broker, subscriber interface, etc.). Then, at regular intervals (e.g., every 10 seconds), the top level component may be configured to perform a get request to the lower levels to check on the status of multiple microservices down there. That is, to get metric “j,” the subscriber interface 76, according to conventional techniques, would normally need to pass the get command down to the module 78f, which then would pass the get command down to the module 78g, which then would pass the get command down to the module 78h, which then would pass the get command down to the module 78j. Upon receiving the get command, the module 78j would capture the j metric and respond back up the chain. Of course, to avoid the usage of extra processing power, the embodiments of the present disclosure can be used to avoid the downward chain of get commands and the upward responses, but instead may predetermine to drive the capturing and self-publication responsibilities or duties to the lower levels. In the example of capturing metric j, the module 78j may be given the responsibility of capturing this metric and passing it up the chain without the need to wait for a get command.

For example, it can be costly to overburden the processor associated with the subscriber interface 76 and other intermediary proxies, particularly as the publisher (e.g., NE) is scaled to include multiple modules 78 and levels. Also, the bidirectional communication downward and then upward within the tree structure can further burden the modules 78 and associated processors when the old method 82 is used. Thus, a goal of configuring the publisher 72 may be to push the subscriptions as far down as possible to avoid message interferences, duplications, bottlenecks, resource contention, imbalanced loads, I/O blocking, wake-up time interval scheduling, and excessive usage of processor power.

In some embodiments, the publisher 72 may include multiple processors. For example, suppose the dashed line represents a border between a first microprocessor and a second microprocessor. In many case, the second microprocessor may be more powerful than the first. Therefore, it would be beneficial to offload the subscription responsibility onto this second microprocessor, to thereby enable parallel processing and to balance the processing load more efficiently.

Furthermore, subscriptions may be handled in a slightly different way with respect to the available functionality described in the present disclosure. For example, instead of having subscriptions honored periodically (e.g., every ten seconds), the lower-level module 78 may capture a significant change in a metric and immediately push the metric up the tree for publication without waiting for the particular time interval or waiting for a get command. Thus, fragments of subscriptions may be provided or published to the subscribers 74, whenever the responsible module 78 deems fit.

According to various embodiments described herein, the publication of data may include publishing telemetry information, such as various metrics that may be captured throughout the system. In some embodiments, these metrics may include one or more of a) processor power, b) card power, c) voltage levels, d) card temperature, e) ambient temperature, f) circuitry health, g) memory available, h) CPU available, i) CPU usage, etc. In other embodiments, there metrics may include PM data, OAM&P data, statistics, Key Performance Indicators (KPIs), and the like.

### Publisher As a Network Element

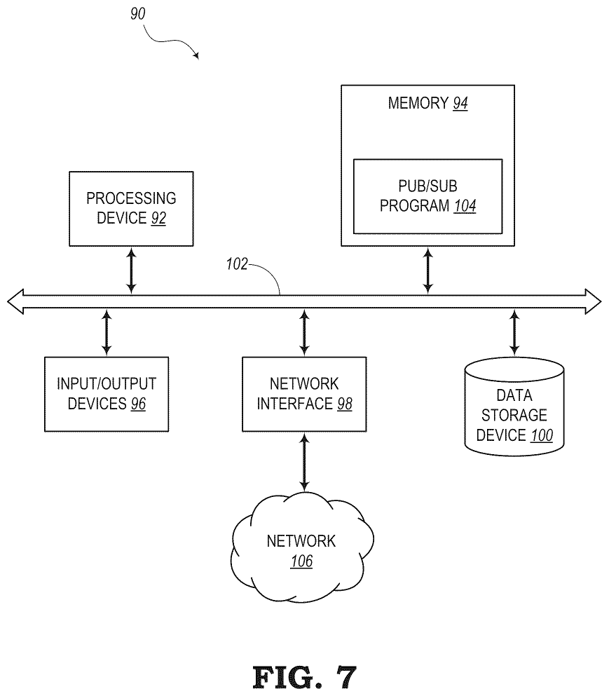

FIG. 7 is a block diagram illustrating an embodiment of a Network Element (NE) 90 configured to act as a publisher. In this embodiment, the NE 90 may include a computing system having a processing device 92, memory 94, Input/Output (I/O) devices 96, a network interface 98, and a data storage device 100, each interconnected via a local bus interface 102. The memory 94 may be configured as a non-transitory computer-readable medium and may store a pub/sub program 104 having computer logic instructions enabling the processing device 92 to perform various pub/sub functions, such as the methodologies described in the present disclosure.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

### Pub/sub Method Using an Upward Push Technique

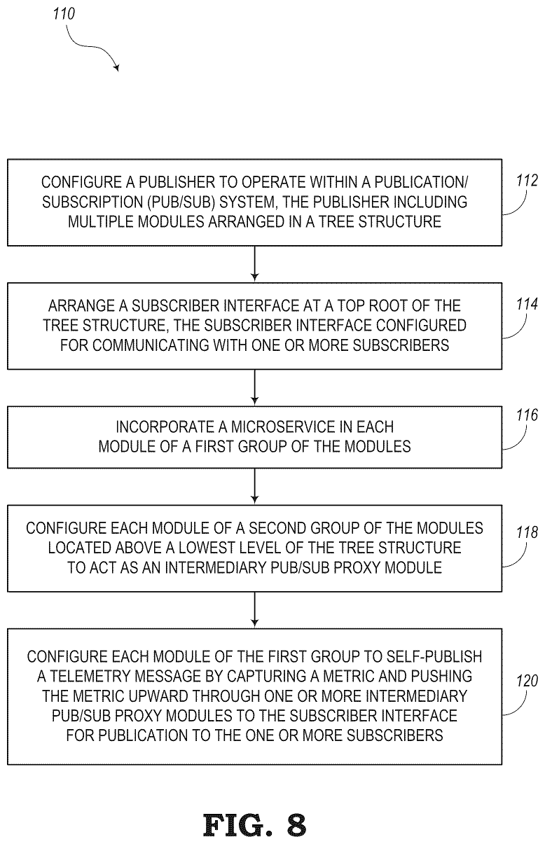

FIG. 8 is a flow diagram illustrating an embodiment of a method 110 for publishing telemetry messages in a simplified manner. In shown in FIG. 8, the method 110 includes a step of configuring a publisher to operate within a publication/subscription (pub/sub) system, wherein the publisher includes multiple modules arranged in a tree structure, as indicated in block 112. The method 110 also includes a step of arranging a subscriber interface at a top root of the tree structure, the subscriber interface configured for communicating with one or more subscribers, as indicated in block 114. Also, the method 110 includes a step of incorporating a microservice in each module of a first group of the modules, as indicated in block 116. The method 110 further includes a step of configuring each module of a second group of the modules located above a lowest level of the tree structure to act as an intermediary pub/sub proxy module, as indicated in block 118. Furthermore, the method 110 includes a step of configuring each module of the first group to self-publish a telemetry message by capturing a metric and pushing the metric upward through one or more intermediary pub/sub proxy modules to the subscriber interface for publication to the one or more subscribers, as indicated in block 120.

According to additional embodiments, the action of self-publishing the telemetry message (block 120) may be prompted without the use of a get command from a higher-level module. The step of configuring each module of the second group to act as an intermediary pub/sub proxy module (block 118) may further include the step of driving self-publishing responsibilities down to lower levels in the tree structure where a metric can be directly captured from a microservice. The metric captured by each module of the first group, for example, may include a) power, b) voltage, c) temperature, d) data service health, e) memory availability, f) CPU usage, and/or g) user log-in information.

In some cases, the publisher may be implemented in a Network Element (NE) of a communication network, wherein the subscriber interface is one of a) a Northbound Interface (NBI), b) a NETCONF interface, and c) a REST API. In other cases, the publisher may be implemented in a software program operating in an enterprise cloud, wherein the subscriber interface is an API and/or an endpoint.

The method 110 may further include a step of setting one or more flag bits in each module of the second group to enable operation of an upward push technique, the one or more flag bits indicating that the respective module is acting as an intermediary pub/sub proxy module to thereby remove a get responsibility of the module and suppress get commands from being passed to one or more lower-level modules. Also, the method 110 may include a step of configuring the subscriber interface to clear or set the one or more flag bits of each module of the second group according to whether the publisher is to be configured to enable operation of a conventional manner or the upward push technique.

The method 110 may further include a step of configuring the subscriber interface to receive one or more telemetry messages from the first group of modules and publish the one or more telemetry messages without delay. In some embodiments, each module of the first group may be configured to self-publish the metric in response to one or more of a) asynchronously detecting an initial state of the respective microservice, b) asynchronously detecting a change in state of the metric, c) synchronously detecting the metric according to a time interval. The subscriber interface and/or one or more of the second group of modules may be configured to aggregate multiple self-published metrics from itself and/or from one or more lower levels.

### Conclusion

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. A publisher operating within a publication/subscription (pub/sub) system, the publisher comprising one or more processing devices configured to implement:
multiple modules arranged in a tree structure; and
a subscriber interface at a top root of the tree structure, the subscriber interface configured for communicating with one or more subscribers,
wherein each module of a first group of the modules includes a microservice,
wherein each module of a second group of the modules located above a lowest level of the tree structure acts as an intermediary pub/sub proxy module, and
wherein each module of the first group is configured to self-publish a telemetry message by capturing a metric and pushing the metric upward through one or more intermediary pub/sub proxy modules to the subscriber interface for publication to the one or more subscribers.

2. The publisher of claim 1, wherein self-publishing the telemetry message is prompted without a get command from a higher level module.

3. The publisher of claim 1, wherein the one or more intermediary pub/sub proxy modules enable self-publishing responsibilities to be driven down to lower levels in the tree structure where a metric can be directly captured from a microservice.

4. The publisher of claim 3, wherein the metric captured by each module of the first group includes one or more of a) power, b) voltage, c) temperature, d) data service health, e) memory availability, f) CPU usage, and g) user log-in information.

5. The publisher of claim 1, wherein the publisher is implemented in a Network Element (NE) of a communication network, and wherein the subscriber interface is one of a) a Northbound Interface (NBI), b) a NETCONF interface, and c) a REST API.

6. The publisher of claim 1, wherein the publisher is implemented in a software program operating in an enterprise cloud, and wherein the subscriber interface is one of an API and an endpoint.

7. The publisher of claim 1, wherein each module of the second group includes one or more flag bits set to indicate that the respective module is acting as an intermediary pub/sub proxy module to thereby remove a get responsibility of the module and suppress get commands from being passed to one or more lower-level modules.

8. The publisher of claim 7, wherein the subscriber interface is configured to clear or set the one or more flag bits of each module of the second group according to whether the publisher is to be configured to operate in a conventional manner or to operate using an upward push technique.

9. The publisher of claim 1, wherein the subscriber interface is configured to receive one or more telemetry messages from the first group of modules and publish the one or more telemetry messages without delay.

10. The publisher of claim 1, wherein each module of the first group is configured to self-publish the metric in response to one or more of a) asynchronously detecting an initial state of the respective microservice, b) asynchronously detecting a change in state of the metric, c) synchronously detecting the metric according to a time interval.

11. The publisher of claim 1, wherein one or more of the subscriber interface and second group of modules are configured to aggregate multiple self-published metrics from itself and/or from one or more lower levels.

12. A method comprising steps of:
configuring a publisher to operate within a publication/subscription (pub/sub) system, the publisher including multiple modules arranged in a tree structure;
arranging a subscriber interface at a top root of the tree structure, the subscriber interface configured for communicating with one or more subscribers;
incorporating a microservice in each module of a first group of the modules;
configuring each module of a second group of the modules located above a lowest level of the tree structure to act as an intermediary pub/sub proxy module; and
configuring each module of the first group to self-publish a telemetry message by capturing a metric and pushing the metric upward through one or more intermediary pub/sub proxy modules to the subscriber interface for publication to the one or more subscribers.

13. The method of claim 12, wherein self-publishing the telemetry message is prompted without a get command from a higher-level module.

14. The method of claim 12, wherein configuring each module of the second group to act as an intermediary pub/sub proxy module further includes the step of driving self-publishing responsibilities down to lower levels in the tree structure where a metric can be directly captured from a microservice, and wherein the metric captured by each module of the first group includes one or more of a) power, b) voltage, c) temperature, d) data service health, e) memory availability, f) CPU usage, and g) user log-in information.

15. The method of claim 12, wherein the publisher is implemented in a Network Element (NE) of a communication network, and wherein the subscriber interface is one of a) a Northbound Interface (NBI), b) a NETCONF interface, and c) a REST API.

16. The method of claim 12, wherein the publisher is implemented in a software program operating in an enterprise cloud, and wherein the subscriber interface is an API and/or an endpoint.

17. The method of claim 12, further comprising the steps of:
setting one or more flag bits in each module of the second group to enable operation of an upward push technique, the one or more flag bits indicating that the respective module is acting as an intermediary pub/sub proxy module to thereby remove a get responsibility of the module and suppress get commands from being passed to one or more lower-level modules; and
configuring the subscriber interface to clear or set the one or more flag bits of each module of the second group according to whether the publisher is to be configured to enable operation of a conventional manner or the upward push technique.

18. The method of claim 12, further comprising the step of configuring the subscriber interface to receive one or more telemetry messages from the first group of modules and publish the one or more telemetry messages without delay.

19. A Network Element (NE) operating in a communication network, the NE comprising:
a processing device; and
memory configured to store a publication/subscription (pub/sub) program having logic instructions for causing the processing device to
configure a publisher to operate within a publication/subscription (pub/sub) system, the publisher including multiple modules arranged in a tree structure,
arrange a subscriber interface at a top root of the tree structure, the subscriber interface configured for communicating with one or more subscribers,
incorporate a microservice in each module of a first group of the modules,
configure each module of a second group of the modules located above a lowest level of the tree structure to act as an intermediary pub/sub proxy module, and
configure each module of the first group to self-publish a telemetry message by capturing a metric and pushing the metric upward through one or more intermediary pub/sub proxy modules to the subscriber interface for publication to the one or more subscribers.

20. The NE of claim 19, wherein each module of the first group is configured to self-publish the metric in response to one or more of a) asynchronously detecting an initial state of the respective microservice, b) asynchronously detecting a change in state of the metric, c) synchronously detecting the metric according to a time interval, and wherein one or more of the subscriber interface and second group of modules are configured to aggregate multiple self-published metrics from itself and/or from one or more lower levels.
